(19) United States
(12) Patent Application Publication
(10) Pub. No.: US 2020/0228769 A1
(43) Pub. Date: Jul. 16, 2020

(54) LENS ROLLOFF ASSISTED AUTO WHITE BALANCE

(71) Applicant: QUALCOMM Incorporated, San Diego, CA (US)

(72) Inventor: Sang Cheol Yu, San Diego, CA (US)

(21) Appl. No.: 16/246,093

(22) Filed: Jan. 11, 2019

(51) Int. Cl. H04N 9/73; H04N 5/235; H04N 9/68

(52) U.S. Cl. CPC H04N 9/735; H04N 9/68; H04N 5/2354

(57) ABSTRACT

A method and apparatus for determining an auto white balance (AWB) gain based on a chroma tint pattern resulting from lens rolloff. The method may include receiving an image captured by a camera module, determining a chroma tint pattern of the image resulting from lens rolloff of the camera module, determining an illuminant under which the image was captured based on the determined chroma tint pattern, determining AWB parameters based at least in part on the determined illuminant, and applying the AWB parameters to the image.

### TECHNICAL FIELD

This disclosure generally relates to image and camera processing, and more particularly, to techniques for auto white balance.

### BACKGROUND

Image capture devices (e.g., digital cameras) are commonly incorporated into a wide variety of devices. In this disclosure, an image capture device refers to any device that can capture one or more digital images, including devices that can capture still images and devices that can capture sequences of images to record video. By way of example, image capture devices may comprise stand-alone digital cameras or digital video camcorders, camera-equipped wireless communication device handsets such as mobile telephones, cellular or satellite radio telephones, camera-equipped tablets or personal digital assistants (PDAs), computer devices that include cameras such as so-called “web-cams,” or any devices with digital imaging or video capabilities.

Image capture devices may be capable of producing imagery under a variety of lighting conditions (e.g., illuminants). For example, image capture devices may operate in environments that include large amounts of reflected or saturated light, as well as in environments that include high levels of contrast. Some example image capture devices include an adjustment module for auto exposure control, auto white balance, and auto focus, in addition to other modules (e.g., a tint adjustment module), to adjust the processing performed by the imaging signal processor hardware.

In image capture devices, adjustment of the image signal processor (“ISP”) is often beneficial to achieve proper white balance. White balance (sometimes called color balance, gray balance or neutral balance) refers to the adjustment of relative amounts of primary colors (e.g., red, green and blue) in an image or display such that neutral colors are reproduced correctly. White balance may change the overall mixture of colors in an image. Without white balance, the display of captured images may contain undesirable tints.

### SUMMARY

In general, this disclosure describes techniques for performing an auto white balance (AWB) process. In particular, the techniques of this disclosure include determining a chroma tint pattern from an image resulting from lens rolloff of a camera module. It has been observed that different ambient lighting conditions produce different chroma tint patterns. A camera processor may use the determined chroma tint pattern to determine an illuminant under which the image was captured. The camera processor may then use the illuminant to determine AWB parameters. In some examples, the illuminant determined from the chroma tint pattern may be used to determine AWB parameters directly. In other examples, a camera processor may use an illuminant determined from a chroma tint pattern as well as an illuminant determined using gray-world assumption techniques to determine the AWB parameters.

In one example of the disclosure, a method for image processing, comprises receiving an image captured by a camera module, determining a chroma tint pattern of the image resulting from lens rolloff of the camera module, determining an illuminant under which the image was captured based on the determined chroma tint pattern, determining auto white balance AWB parameters based at least in part on the determined illuminant, and applying the AWB parameters to the image.

In another example, this disclosure describes an apparatus configured for image processing, the apparatus comprising a memory configured to store an image captured by an image sensor of a camera module, and one or more processors in communication with the memory, the one or processors configured to receive the image captured by the camera module, determine a chroma tint pattern of the image resulting from lens rolloff of the camera module, determine an illuminant under which the image was captured based on the determined chroma tint pattern, determine AWB parameters based at least in part on the determined illuminant, and apply the AWB parameters to the image.

In another example, this disclosure describes an apparatus configured for image processing, the apparatus comprising means for receiving an image captured by a camera module, means for determining a chroma tint pattern of the image resulting from lens rolloff of the camera module, means for determining an illuminant under which the image was captured based on the determined chroma tint pattern, means for determining AWB parameters based at least in part on the determined illuminant, and means for applying the AWB parameters to the image.

In another example, this disclosure describes a non-transitory computer-readable storage medium storing instructions that, when executed, causes one or more processors to receive an image captured by a camera module, determine a chroma tint pattern of the image resulting from lens rolloff of the camera module, determine an illuminant under which the image was captured based on the determined chroma tint pattern, determine AWB parameters based at least in part on the determined illuminant, and apply the AWB parameters to the image.

The details of one or more aspects of the disclosure are set forth in the accompanying drawings and the description below. Other features, objects, and advantages of the techniques described in this disclosure will be apparent from the description, drawings, and claims.

### BRIEF DESCRIPTION OF DRAWINGS

FIG. 1 is block diagram of an exemplary device that may implement techniques for determining illuminants to support an automatic white balance process in accordance with this disclosure.

FIG. 2 is a block diagram showing the operation of an image signal processor performing an automatic white balance process.

FIG. 3 is a block diagram showing a chroma tint pattern automatic white balance unit.

FIG. 4 is a conceptual diagram showing the comparison of a determined chroma tint pattern to predefined chroma tint patterns.

FIG. 5 is a block diagram showing a gray-world assumption automatic white balance unit operating in conjunction with a chroma tint pattern automatic white balance unit.

FIG. 6 is a flowchart illustrating an example method for performing automatic white balance according to the techniques of the disclosure.

### DETAILED DESCRIPTION

This disclosure describes image processing techniques that facilitate the determination of a lighting condition (sometimes referred to as the illuminant condition, current illuminant, or color temperature) associated with an image obtained by an image sensor, such as a camera (e.g., a digital camera). The perceived colors of objects are dependent on the type of light (e.g. the lighting condition or illuminant) that is illuminating the object (e.g., indoor incandescent light, indoor fluorescent light, daylight at noon, daylight in late afternoon, etc.). Color perceived by the human eye is basically the combination of the illuminant and the surface of an object, which has a specific color. Thus, the color stimulus perceived by the human eye is different depending on the illuminant. The human visual system can automatically “adjust” or “remove” the impact of the illuminant so that the color perception is closer to the color of the object. This consistent color perception helps humans to recognize colors.

In digital cameras, a white balance process may be applied to a captured image to adjust or remove the impact of the illuminance. The white balance process may involve application of white balance gains and/or scaling to respective colorimetric channels of the image (e.g., RGB, XYZ, or YUV color channels). The gains may be defined for the illuminant for the white balance process. White balance is a process used to correct for image sensor responses in order to better match an image with a user's perceptual experience of the object being imaged. As an example, the white balance process is designed to make gray objects actually appear gray in the processed image.

If an incorrect illuminant is identified, white balance can impair image quality in some cases. If the correct illuminant is identified, however, white balance usually improves image quality. As mentioned above, gains and/or scaling can then be applied to various color channels so that the white area actually appears white. This often improves the color fidelity of saturated color areas of an image as well, by adjusting those colors using the gains from the white balance process. The gains or scaling applied to achieve white balance may be predetermined for different illuminants. Accordingly, it is beneficial to determine the approximate illuminant applicable to an image so that an appropriate set of white balance gains can be selected.

In some examples, a user of an image capture device may select or indicate an illuminant under which an image was captured. In other examples, the image capture device itself may automatically determine the most likely illuminant and perform white balancing based on the determined light condition. Such a process is sometimes referred to as automatic white balance (AWB). In order to better reflect the colors of a scene, an AWB algorithm performed by a processor on a camera may attempt to determine the illuminants of the scene and set the white balance accordingly.

However, AWB algorithms have difficulty setting the white balance in some situations. For example, gray and blue have very similar color properties under different illuminants. Accordingly, when there are both gray and blue colors in the same scene, an incorrect AWB setting may cause one of the colors to be displayed incorrectly. For example, the camera may capture the sky as gray instead of blue. Incorrect AWB settings may also occur when there are few or no gray pixels in the scene. For example, an image comprising mostly yellow pixels may be result in incorrect AWB settings that cause the yellow object in the image to appear bluish.

Some example AWB algorithms are based on a gray-world assumption. An image processor may be configured to analyze an image and obtain some “gray stats” within the field of view to determine the current color temperature (e.g., current illuminant). Such AWB algorithms are only a probability-based estimation. Without measuring the ambient light directly, the image processor is only capable of making an estimation of the current illuminant.

A camera could be configured with a colorimeter (i.e., color temperature sensor) to directly measure the ambient light, but colorimeters are expensive and large. Colorimeters also have a direction dependency. For example, AWB parameters derived from the output of a colorimeter may be affected when the color temperature measured at the sensor is different than the temperature in the desired field of view.

In order to approve the accuracy of determining AWB parameters, without increasing the cost and/or size of a camera module, this disclosure describes techniques for determining an illuminant and AWB parameters based on a chroma tint pattern of an image resulting from camera lens rolloff. Lenses exhibit rolloff because the distance between the lens and the sensor is not uniform. The distance from the center of the lens to the sensor is shorter than the distance from the edges of the lens to the sensor due to the orthogonality of the lens to the sensor. The brightness (e.g., luminance) captured at the corners of an image sensor is darker than at the center. An image processor may normalize such non-uniform gain using a gain table. This luminance non-uniformity is not generally helpful in determining an illuminant and AWB parameters, because the luminance non-uniformity is consistent across different color temperatures.

However, lens rolloff also results in a chrominance non-uniformity. That is, due to infrared (IR) cutoff filters used in lenses, colors are not detected uniformly across the sensor. The non-uniformity of colors detected by the sensor may be referred to as a chroma tint pattern. Unlike the luminance non-uniformity, the chroma tint pattern resulting from lens rolloff is different for different illuminants. This disclosure describes techniques for determining chroma tint patterns in captured images, determining an illuminant from the determined chroma tint patterns, and then deriving AWB parameters based on the determined illuminant. In some examples, the techniques of this disclosure include the use of one or more pre-measured chroma tint patterns that are used in comparisons with a currently measured chroma tint pattern to estimate the current illuminant. In this way, illuminants may be determined without the need for a certain number of gray pixels and without the need for the use of an expensive and large colorimeter.

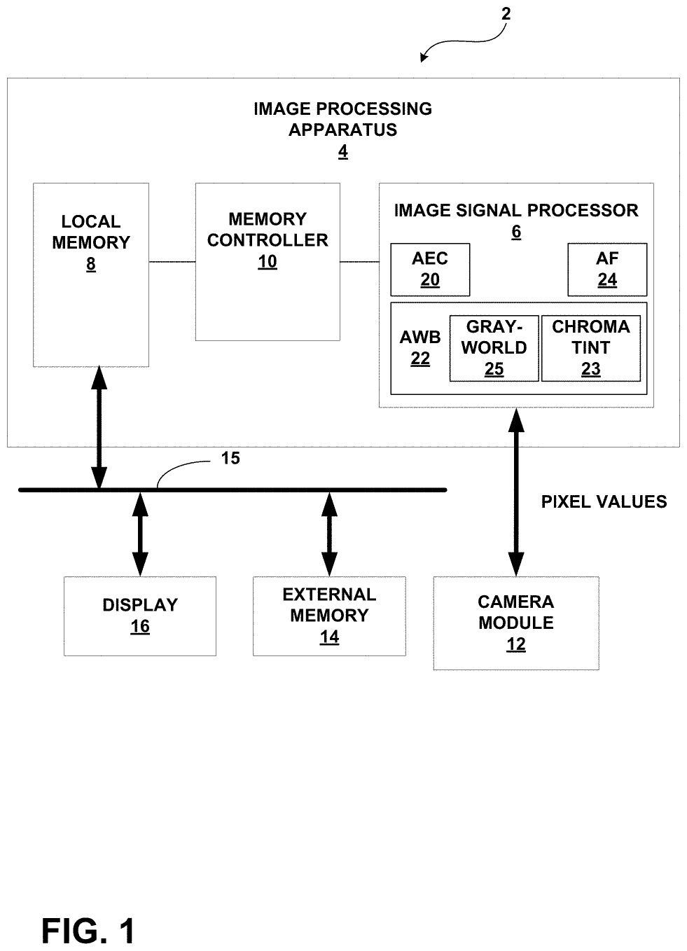

FIG. 1 is a block diagram illustrating a device 2 that may be configured to perform the techniques of this disclosure. Device 2 may form part of an image capture device, or a digital video device capable of coding and transmitting and/or receiving video sequences. By way of example, device 2 may comprise a stand-alone digital camera or video camcorder, a wireless communication device such as a cellular or satellite radio telephone, a personal digital assistant (PDA), a tablet computer, a laptop computer, a so-called “smartphone,” or any device with imaging or video capabilities in which image processing is desirable.

As shown in FIG. 1, device 2 includes an image processing apparatus 4 to store raw image data and perform various processing techniques on such data. Apparatus 4 may comprise a so called “chip set” that includes a digital signal processor (DSP) on-chip memory, and possibly hardware logic or circuitry. More generally, apparatus 4 may comprise any combination of processors, hardware, software or firmware, and the various components of apparatus 4 may be implemented as such. Also, apparatus 4 may comprise a single integrated chip or an encoder/decoder (CODEC), if desired.

In the illustrated example of FIG. 1, image processing apparatus 4 includes a local memory 8, a memory controller 10 and an image signal processor 6. Image signal processor 6 may be a general-purpose processing unit or may be a processor specially designed for imaging applications for a handheld electronic device. As shown, image signal processor 6 is connected to, and in data communication with, local memory 8 and external memory 14 via memory controller 10. In some examples, local memory 8 may be incorporated in image signal processor 6, for example, as cache memory.

As shown in FIG. 1, image signal processor 6 may be configured to execute an AEC (auto exposure control) process 20, an AWB process 22, and an auto focus (AF) process 24. In some examples, image signal processor 6 may include hardware-specific circuits (e.g., an application-specific integrated circuit (ASIC)) configured to perform the AEC, AWB, and/or AF processes. In other examples, image signal processor 6 may be configured to execute software and/or firmware to perform the AEC, AWB, and/or AF processes. When configured in software, code for AEC process 20, AWB process 22, and/or AF process 24 may be stored in local memory 8 and/or external memory 14. In other examples, image signal processor 6 performs the AEC, AWB, and/or AF processes using a combination of hardware, firmware, and/or software. When configured as software, AEC process 20, AWB process 22, and/or AF process 24 may include instructions that configure image signal processor 6 to perform various image processing and device management tasks, including the AWB and AEC techniques of this disclosure.

AEC process 20 may include instructions for configuring, calculating, and/or storing an exposure setting of a camera module 12. An exposure setting may include the shutter speed and aperture setting to use to capture images. In accordance with techniques of this disclosure, image signal processor 6 may use depth information captured by camera module 12 to better identify the subject of an image and make exposure settings based on the identified subject. AF process 24 may include instructions for configuring, calculating and/or storing an auto focus setting of camera module 12.

AWB process 22 may include instructions for configuring, calculating and/or storing an AWB setting (e.g., an AWB gain) that may be applied to an image captured by camera module 12. Image signal processor 6 may be configured to perform the techniques of this disclosure for lens rolloff-assisted AWB processing. As will discussed in more detail below, AWB process 22 may include gray-world AWB unit 25 and chroma tint AWB unit 23. Image signal processor 6 may receive an image captured by camera module 12, determine a chroma tint pattern of the image resulting from lens rolloff of the camera module, determine an illuminant under which the image was captured based on the determined chroma tint pattern, determine AWB parameters based at least in part on the determined illuminant, and apply the AWB parameters to the image.

Local memory 8 stores raw image data and may also store processed image data following any processing that is performed by image signal processor 6. Local memory 8 may be formed by any of a variety of non-transitory memory devices, such as dynamic random-access memory (DRAM), including synchronous DRAM (SDRAM), magnetoresistive RAM (MRAM), resistive RAM (RRAM), or other types of memory devices. Memory controller 10 controls the memory organization within local memory 8. Memory controller 10 also controls memory loads from local memory 8 to image signal processor 6 and write backs from image signal processor 6 to local memory 8. The images processed by image signal processor 6 may be loaded directly into image signal processor 6 from camera module 12 following image capture or may be stored in local memory 8 during the image processing.

As noted, device 2 may include a camera module 12 to capture the images that are processed, although this disclosure is not necessarily limited in this respect. Camera module 12 may comprise arrays of solid state sensor elements such as complementary metal-oxide semiconductor (CMOS) sensor elements, charge coupled device (CCD) sensor elements, or the like. Alternatively, or additionally, camera module 12 may comprise a set of image sensors that include color filter arrays (CFAs) arranged on a surface of the respective sensors. Camera module 12 may be coupled directly to image signal processor 6 to avoid latency in the image processing. Camera module 12 may be configured to capture still images, or full motion video sequences, in which case the image processing may be performed on one or more image frames of the video sequence.

Camera module 12 may send pixel values (e.g., in a Bayer or RGB format), and/or raw statistics messages describing the captured image to image signal processor 6. The information obtained from camera module 12 may be used in AEC process 20 and AWB process 22, as will be described in more detail below. In general, image signal processor 6 may be configured to analyze the raw statistics and depth information to calculate and/or determine imaging parameters, such as sensor gain, R/G/B gain, AWB gain, shutter speed, aperture size, and the like. The calculated and/or determined imaging parameters may be applied to the captured image and/or sent back to camera module 12 to adjust exposure and/or focus setting.

Device 2 may include a display 16 that displays an image following the image processing described in this disclosure. After such image processing, the image may be written to local memory 8 or external memory 14. The processed images may then be sent to display 16 for presentation to the user. Display 16 may display other information, including visual representations of files stored in a memory location (e.g., external memory 14), software applications installed in image signal processor 6, user interfaces, network-accessible content objects, and other information.

In some examples, device 2 may include multiple memories. For example, device 2 may include external memory 14, which typically comprises a relatively large memory space. External memory 14, for example, may comprise DRAM or FLASH memory. In other examples, external memory 14 may comprise a non-volatile memory or any other type of data storage unit. In contrast to external memory 14, local memory 8 may comprise a smaller and faster memory space, although this disclosure is not necessarily limited in this respect. By way of example, local memory 8 may comprise SDRAM. In any case, external memory 14 and local memory 8 are merely exemplary, and may be combined into the same memory part, or may be implemented in a number of other configurations.

Device 2 may also include a transmitter (not shown) to transmit the processed images or coded sequences of images to another device. Indeed, the techniques of this disclosure may be used in handheld wireless communication devices (such as so-called smartphones) that include digital camera functionality or digital video capabilities. In that case, the device would also include a modulator-demodulator (MODEM) to facilitate wireless modulation of baseband signals onto a carrier waveform in order to facilitate wireless communication of the modulated information.

Local memory 8, display 16 and external memory 14 (and other components if desired) can be coupled via a communication bus 15. A number of other elements may also be included in device 2, but are not specifically illustrated in FIG. 1 for simplicity and ease of illustration. The architecture illustrated in FIG. 1 is merely exemplary, as the techniques described herein may be implemented with a variety of other architectures.

As noted above, white balance can be an important process for digital camera applications or other applications that present images to users. Again, white balance is typically used to correct an image captured by an image sensor in order to better match the colors of the captured image with a human viewer's perceptual experience of the object being captured. Essentially, white balance is a process of identifying one or more colors in an image that should appear white under the identified lighting. Gains or other scaling can then be applied to various color channels of the image so that the white area actually appears white. White balance typically refers to this process of scaling the color channels to adjust for illuminants. The scaling of color channels associated with a digital image can often improve the color fidelity of saturated color areas of an image as well by adjusting those colors using the gains from the white balance process.

However, white balance is dependent upon the illuminant identified for an image. If the wrong illuminant is identified, white balance can actually impair image quality in some cases. If the correct illuminant is identified, however, white balance usually improves image quality. According to the techniques of this disclosure, techniques are described for improving the determination of actual illuminants associated with an image. In particular, this disclosure describes techniques whereby image signal processor 6 determines a chroma tint pattern of a captured image and uses the determined chroma tint pattern to improve the accuracy of determining an illuminant for an AWB process.

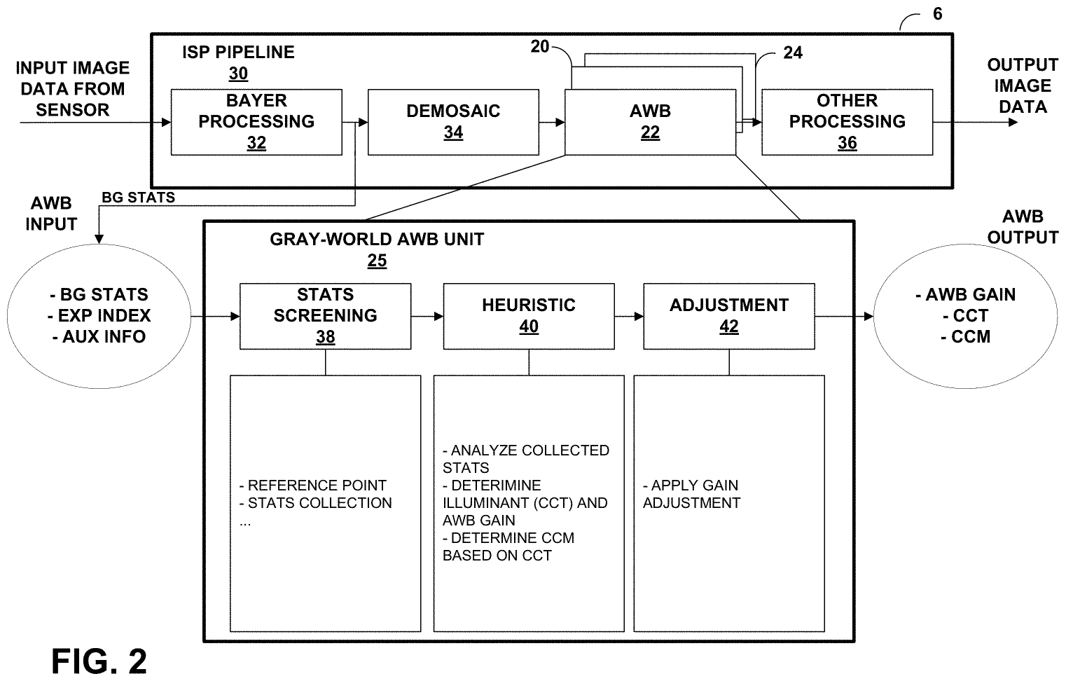

FIG. 2 is a block diagram showing an example of the operation of image signal processor 6 performing an automatic white balance process in more detail. Image signal processor 6 may be configured to execute an image signal processing (ISP) pipeline 30 to process image data input to image signal processor 6. The example of FIG. 2 is focused on AWB process 22. However, ISP pipeline 30 may also include AEC process 20 and AF process 24, which may be performed in parallel, or serially, with AWB process 22.

In the example of FIG. 2, image signal processor 6 receives input image data from camera module 12. The input image data includes color data of the image. The color data received for the input image is in a Bayer format. Rather than capturing red (R), green (G), and blue (B) values for each pixel of an image, image sensors may use a Bayer filter mosaic (or more generally, a color filter array (CFA)), where each photosensor of a digital photo sensor captures a different one of the RGB colors. Typical filter patterns for a Bayer filter mosaic include 50% green filters, 25% red filters, and 25% blue filters.

Bayer processing unit 32 may perform one or more initial processing techniques on the raw Bayer data received by image signal processor 6, including, for example, black level subtraction, rolloff correction, bad pixel correction, and/or denoising. Demosaic processing unit 34 may be configured to convert the processed Bayer image data into RGB values for each pixel of the image. As explained above, Bayer data may only include values for one color channel (R, G, or B) for each pixel of the image. Demosaic processing unit 34 may determine values for the other color channels of a pixel by interpolating from color channel values of nearby pixels.

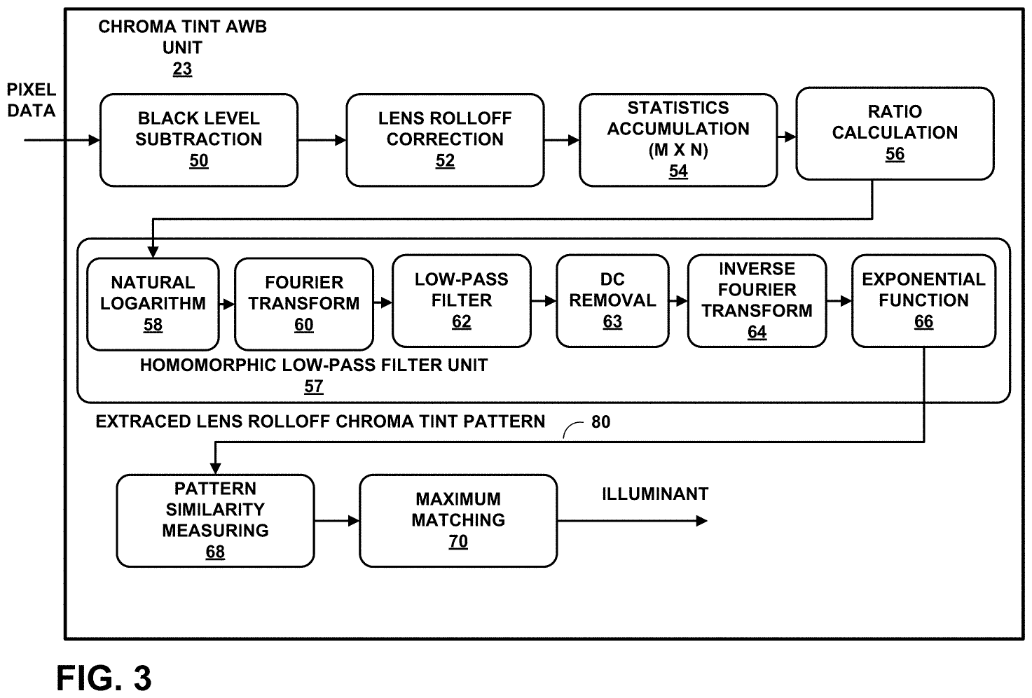

AWB process 22 analyzes information relating to the captured image to determine an illuminant, from among a plurality of possible illuminants, and determines an AWB gain to apply to the captured image. FIG. 2 shows the example of AWB process 22 determining AWB parameters using gray-world AWB unit 25. Gray-world AWB unit 25 determines AWB parameters using the so-called “gray-world assumption” techniques. Techniques relating to determine AWB parameters using a chroma tint pattern will be discussed below with reference to FIG. 3.

As shown in FIG. 2, example inputs to gray-world AWB unit 25 includes Bayer grid (BG) statistics of the captured image, an exposure index (e.g., the brightness of the captured image), and auxiliary information, which may include depth information. The BG statistics represent the actual raw color values in the captured image in the Bayer domain. However, it should be understood that it is not necessary to use BG statistics, and instead, RGB values of each pixel after demosaicing may also be used by gray-world AWB unit 25.

Stats screening process 38 identifies pixel values in the image that are close to gray tones (e.g., called near-gray pixels) as defined by various different illuminants. That is, what color values are considered to be gray may be different for each of a plurality of illuminants. Gray values for various illuminants may be predefined and stored as a reference point for each illuminant.

As one example, seven different illuminants may be defined using reference points that are calibrated according to the following TABLE 1.

TABLE 1

| Illuminant | R/G Ratio | B/G Ratio |
|---|---|---|
| D65 (outdoor- midday) | 0.65 | 0.83 |
| Shade (outdoor) | 0.60 | 0.90 |
| Incandescent (indoor) | 1.10 | 0.51 |
| Cool White (indoor) | 0.76 | 0.54 |
| Warm Fluorescent (indoor) | 0.87 | 0.59 |
| Horizon (outdoor) | 1.28 | 0.46 |
| D50 (outdoor) | 0.77 | 0.69 |

Each of the illuminants in Table 1 is a predefined standard that is intended to represent a theoretical source of visible light for a given sensor module used by camera module 12. Colors, including gray values and white values, will look different to the human eye under different light sources. Stats screening process 38 may consider more or fewer illuminants than shown in Table 1. In general, stats screening process 38 may consider both a plurality of indoor illuminants (e.g., as produced by various types of light bulbs) as well as a plurality of different outdoor illuminants (e.g., as produced by the sun at different parts of the day or in different conditions).

As can be seen in Table 1, reference point gray values may be defined based on a ratio of R/G values in a pixel and/or B/G values in a pixel. Based on these parameters, gray point lines can be defined for each respective illuminant in a two-dimensional color space. For comparison purposes, a bounding rectangle on the Cb-Cr (blue and red chroma values) domain can also be obtained to collectively bound all of the gray point lines.

Stats screening process 38 identifies near-gray pixels of an image for a plurality of different illuminants based on the statistics of the image (e.g., R/G and or B/G ratios of a pixel or region of an image). In some examples, stats screening process 38 identifies the near-gray pixels based on gray point lines defined for the different illuminants (e.g., the reference points) and bounding volumes (e.g., cylindrical bound volumes) defined around the gray point lines. For example, gray point lines may be defined in a three-dimensional color space for the different illuminants. These gray point lines define actual gray colors for the respective illuminants, and generally differ within the three-dimensional color space for the different illuminants. In other words, different illuminants define different gray point lines within the same color space. For each of the gray point lines associated with the different illuminants, a cylindrical bounding volume is defined about the respective gray point lines. In one example, a radius of approximately six pixels may be used to define the cylindrical bounding volumes about the respective gray point lines. Gray-world AWB unit 25 may simply select the illuminant having the greatest number of near-gray pixels associated with the respective bounding volume.

After statistics collection for the various illuminants, heuristic process 40 may determine an auto white balance gain for the captured image. Heuristic process 40 may be configured to analyze the collected statistics of the image (e.g., the number of near-gray pixels identified per illuminant). In some examples, heuristic process 40 selects one of the illuminants based on the near-gray pixels identified for the different illuminants based at least in part on a pixel count for that respective illuminant. In other words, heuristic process 40 may use the pixel statistics associated with the most probable respective illuminant to determine the auto white balance gain.

The most probable respective illuminant may be the illuminant for which the most pixels (e.g., R/G pixel statistics) of the image fall within the defined bounding volume for that illuminant. In this sense, the techniques of this disclosure may rely somewhat on the “gray world assumption,” insofar as the illuminant for which the most pixels of the image fall within the defined bounding volume can used for determining the auto white balance gain. Other factors, however, may also be used along with the pixel counts to determine the auto white balance gain, including the number of green pixels in the image, the number of blue pixels in the image, and/or the intensity of the pixels of the image. The determined auto white balance gain is a scaling factor that may be multiplied to the pixel values of the image in order to make white and gray pixels in the image appear correctly white and gray for a particular illuminant.

The auto white balance gain determined by heuristic process 40 may be used to determine a current illuminant. In this context, the “current” illuminant is the illuminant that most closely matches the lighting conditions for the current image being processed. Each of a plurality of predefined illuminants may have associated predefined auto white balance gains. Heuristic process 40 may compare the auto white balance gain determined using the techniques described above with the predefined auto white balance gains associated with the plurality of illuminants. Heuristic process 40 selects the illuminant with the associated predefined auto white balance gain that most closely matches the determined auto white balance gain as the current illuminant. The current illuminant selected by heuristic process 40 may be defined by a correlated color temperature (CCT). A CCT is a measure of the appearance of the colors of a light source relative to a blackbody.

In addition, based on the CCT of the determined current illuminant, heuristic process 40 may optionally determine a color correction matrix (CCM) to apply to the white balance adjusted image. A CCM may be used in a color balance process to adjust the intensities of colors. Often, given a particular CCT, it is preferable to adjust the colors in an image so that warmer or cooler tones are more prevalent.

Once the AWB gain is determined, adjustment process 42 may apply the determined AWB gain to the image. In particular, adjustment process 42 typically involves applying AWB gains to colorimetric channels (e.g., RGB) of the image. As an example, adjustment process 42 may determine a white reference area in the image, and then adjust that area as well as other areas of the image by applying selected gains (for that illuminant) on the color channels in order to improve the whiteness of the white reference area. The application of these gains to color channels may also improve color fidelity of areas of the image that exhibit highly saturated colors.

After AWB process 22 is completed, other processing unit 36 may apply additional processing to the image. The additional processing may include color, tone, and/or spatial processing of the image. For example, other processing unit 36 may use the CCM generated from the CCT of the determined current illuminant current illuminant to apply a color balance process to the image.

FIG. 3 is a block diagram showing a chroma tint pattern automatic white balance unit 23, which may form part of AWB process 22. Non-uniform chroma tint can be observed in the images captured by digital cameras. This non-uniform chroma tint results from the use of on an IR cut-off filter on the camera lens of camera module 12. The non-uniform chroma tint may be referred to as lens rolloff. The non-uniform chroma tint is non-uniform due to the varying spectrum response depending on light incident angle on the lens of camera module 12. The non-uniform chroma tint problem is often more severe for mobile phone cameras due to the small size of the lens.

Another property of this non-uniform chroma tint is that the pattern of the non-uniform chroma tint is different depending on the ambient light source. This is due to the differing spectral power distribution of different ambient light sources. Even with different color objects, the non-uniform chroma tint pattern stays substantially the same given a particular ambient light source (i.e., the illuminant). Chroma tint AWB unit 23 is configured to use this feature of the chroma tint pattern resulting from the lens rolloff to determine the current illuminant and AWB parameters.

In the example of FIG. 3, AWB process 22 uses chroma tint AWB unit 23 to determine AWB parameters. Chroma tint AWB unit 23 may receive raw image data from camera module 12. Like gray-world AWB unit 25, the raw image data includes Bayer grid (BG) statistics of the captured image, an exposure index (e.g., the brightness of the captured image), and auxiliary information, which may include depth information. The BG statistics represent the actual raw color values in the captured image in the Bayer domain. In the context of FIG. 3, the raw image data will be referred to as pixel data.

Chroma tint AWB unit 23 receives the pixel data from camera module 12 and black level subtraction unit 50 adjusts values of the pixel data that should have registered as black to zero. In effect, black level subtraction unit 50 subtracts out false readings from the image sensor of camera module 12.

Lens rolloff correction unit 52 then applies lens rolloff correction to the pixel data. Lens rolloff correction unit 52 may be configured to correct for both luminance non-uniformity and chrominance non-uniformity resulting from lens rolloff. As described above, luminance non-uniformity is generally consistent across all lighting condition (e.g., is nearly the same for all illuminants). Lens rolloff correction unit 52 may correct for luminance non-uniformity using a gain table (also called a reference light condition rolloff table). The gain table indicates the gain to apply for each pixel of the captured image depending on the location of the pixel sensor.

Lens rolloff correction unit 52 may also correct for luminance non-uniformity. As one example, lens rolloff correction 52 may correct for a particular chroma tint pattern for a specific lighting condition (e.g., TL84) from the chroma values of the pixel data. TL84 is just one example illuminant that may be used by lens rolloff correction unit 52. However, the chroma tint pattern for any illuminant may be used. As discussed above, the chrominance non-uniformity (e.g., chroma tint pattern) is different for different illuminants. As such, even if a chroma tint pattern for a particular lighting condition is removed from the pixel data, a non-zero chroma tint pattern will still result for images captured under lighting conditions other than TL84.

After lens rolloff correction, statistics accumulation unit 54 may accumulate the statistics (e.g., the pixel values in the R, G, and B color channels) of the captured image. For example, statistics accumulation unit 54 may divide the image into a grid of M×N blocks. The pixel values of each M×N block (also called a bin) may be accumulated and averaged. The size of the M×N blocks of the image used for statistics accumulation may be configurable. The larger the blocks, and thus the smaller number of blocks, may allow for faster computations. Smaller and more numerous blocks may be slower to compute, but may allow for the determination of a more accurate chroma tint pattern. Example blocks sizes include 64×48 pixels and 32×24 pixels.

Ratio calculation unit 56 receives the statistics (e.g., the averaged pixel values) of each of the M×N blocks. Ratio calculation unit 56 then calculates a ratio of the red and green pixel values (R/G) for each BIN. Ratio calculation unit 56 also calculates a ratio of the blue and green pixel values (B/G) for each bin. The R/G and B/G ratios produced by ratio calculation unit 56 represent both the reflective component of the image (e.g., chrominance) as well as the chroma tint pattern. The reflective component is present in high frequency components for the ratios, while the chroma tint pattern is present in low frequency components of the ratios.

To extract the chroma tint pattern from the calculated ratios, chroma tint AWB unit 23 may then process the calculated ratios with homomorphic low-pass filter unit 57. Homomorphic low-pass filter unit 57 applies a homomorphic low-pass filter to the ratios to extract the chroma tint pattern. Homomorphic low-pass filtering may be useful for this application, as homomorphic filtering generally normalizes brightness across an image and increases contrast. In addition, homomorphic low-pass filtering may be useful for extracting a chroma tint pattern, as the chroma tint pattern is generally present in very low frequency components of the calculated ratios. Homomorphic low-pass filtering is one example of a low-pass filter that is particularly suited for extracting low frequency components. However, it should be understood that any type of low-pass filter may be used for extracting the chroma tint pattern from the calculated ratios.

Homomorphic low-pass filter unit 57 may include a natural algorithm unit 59, a Fourier transform unit 60, a low-pass filter unit 62, a DC removal unit 63, an inverse Fourier transform unit 64, and an exponential function unit 66. Natural logarithm unit 58 applies a natural logarithm to the R/G and GB ratios calculated by ratio calculation unit 56. Fourier transform unit 60 transforms the ratios (after application of the natural logarithm) from the spatial domain to the frequency domain. Fourier transform unit 60 may use any techniques for applying a Fourier transform.

Low-pass filter 62 then filters out the high frequency components of the ratios in the frequency domain. Low-pass filter 62 may be any type of low-pass filter. One example is a Gaussian low-pass filter. The frequency band for the low-pass filter may be configurable based on a Gaussian low-pass filter σ value (e.g., less than 0.01π rad/sample).

DC removal unit 63 then removes the DC component (e.g., the average of the signal) of the filtered ratios in the frequency domain. In effect the DC component represents the actual average color of the image at each bin. The DC component is not needed to obtain the chroma tint pattern.

Inverse Fourier transform unit 64 then transforms the remaining low frequency components of each bin, without DC component, from the frequency domain back into the spatial domain. Inverse Fourier transform unit 64 applies the inverse of the Fourier transform applied by Fourier transform unit 60. Exponential function unit 66 applies an exponential function (e.g., e′) to the resulting filtered ratios in each bin. Exponential function unit 66 reverses the process applied by natural logarithm unit 58. The output of exponential function 66 is the extracted lens rolloff chroma tint pattern 80.

Pattern similarity measuring unit 68 receives chroma tint pattern 80 and then compares chroma tint pattern 80 to one or more predefined chroma tint patterns. Each of the predefined chroma tint patterns represents a particular chroma tint pattern produced by a particular illuminant (e.g., D65, TL84, incandescent, D50, shade, etc.). The predefined chroma tint patterns may be stored in a memory on camera module 12 or may be stored in a memory accessible by image signal processor 6. In some examples, the predefined chroma tint patterns may be calculated based on the actual lens rolloff produced by the lens of camera module 12. In other examples, the predefined chroma tint patterns may be calculated based on testing a sample of camera modules that may be used for a particular device (e.g., a mobile phone). In some examples, the predefined chroma tint patterns may be periodically updated, including updated by performing a testing procedure on camera module 12 using known illuminants.

Pattern similarity measuring unit 68 may be configured to determine a similarity score between the extracted chroma tint pattern 80 and each of the predefined chroma tint patterns. Recall that lens rolloff correction unit 52 applied a lens rolloff correction for a certain predefined lighting condition, such as TL84. As such, in this example, if the image used to extract chroma tint pattern 80 was actually taken under the TL84 illuminant, pattern similarity measuring unit 68 would be expected to produce a similarity score that approaches 1.0 (e.g., perfect match) when comparing chroma tint pattern 80 to the predefined chroma tint pattern that would be produced for TL84 (Tint_{reflightTL84}). Tint_{reflightTL84} is the predefined chroma tint pattern for the TL 84 illuminant. Pattern similarity measuring unit 68 may also measure the similarity between chroma tint pattern 80 and the predefined chroma tint patterns for other illuminants, e.g., D75 (Tint_{reflightD75}), D65 (Tint_{reflightD65}), D50 (Tint_{reflightD50}), CW (Tint_{reflightCW}), Incandescent (Tint_{reflightI}), Horizon (Tint_{reflightHor}), etc.

In one example of the disclosure, pattern similarity measuring unit 68 may be configured to determine similarity scores between chroma tint pattern 80 and the predefined chroma tint patterns using a 2D similarity measure. Examples of such similarity measures include a mean of absolute differences (MAD) score or a probability distribution function (PDF) matching score. However, it should be understood that any type of similarity score or comparison may be used. The more similar chroma tint pattern 80 is to one of the predefined chroma tint patterns, the more likely it is that the image was captured under the illuminant associated with the most similar predefined chroma tint pattern.

In one example, pattern similarity measuring unit 68 may determine a MAD score using the following equation:

$${MAD}_{{ }^{reflightA}} = \frac{1}{n * m} {\sum }_{i = 0}^{n} {\sum }_{j = 0}^{m} \vert {Tint}_{{ }^{reflightA , i , j}} - T i n {t}_{curlight , i , j} \vert$$

The variables m and n refer to horizontal and vertical grid number, respectively. For example, for a 100×100 pixel image, a 5×5 m×n grid accumulation means each bin size is 20×20 pixels. Averaged bin data would be a 5×5 matrix.

MAD_{reflightA} is the MAD score for an illuminant A when comparing the extracted chroma tint pattern 80 (Tint_{curlight,i,j}) to the predefined chroma tint pattern for illuminant A (Tint_{reflightA,i,j}). “A” is a variable that represents a particular illuminant. The indices i and j reference the particular bin on which the MAD score is calculated. The difference between chroma tint pattern 80 and the predefined chroma tint pattern for illuminant A are determined for each of the bins of the image and are averaged.

Pattern similarity measuring unit 68 computes a similarity score from the MAD score using the following equation:

$$S i m i l a r i t y S c o r {e}_{{ }^{reflightA}} = 100 \{ 1 - \frac{M A {D}_{{ }^{reflightA}}}{M A {D}_{max}} \}$$

SimilarityScore_{reflightA} is the similarity score for illuminant A and MADₘₐₓ is the maximum possible MAD score.

Maximum matching unit 70 may then receive the similarity scores from pattern similarity measuring unit 68 and determine the current illuminant based on the similarity scores. In some examples, maximum matching unit 70 may simply select the illuminant associated with the predefined chroma tint pattern that has the highest similarity score as the current illuminant for the image. AWB process 22 may then determine AWB parameters using the selected illuminant using the techniques described above.

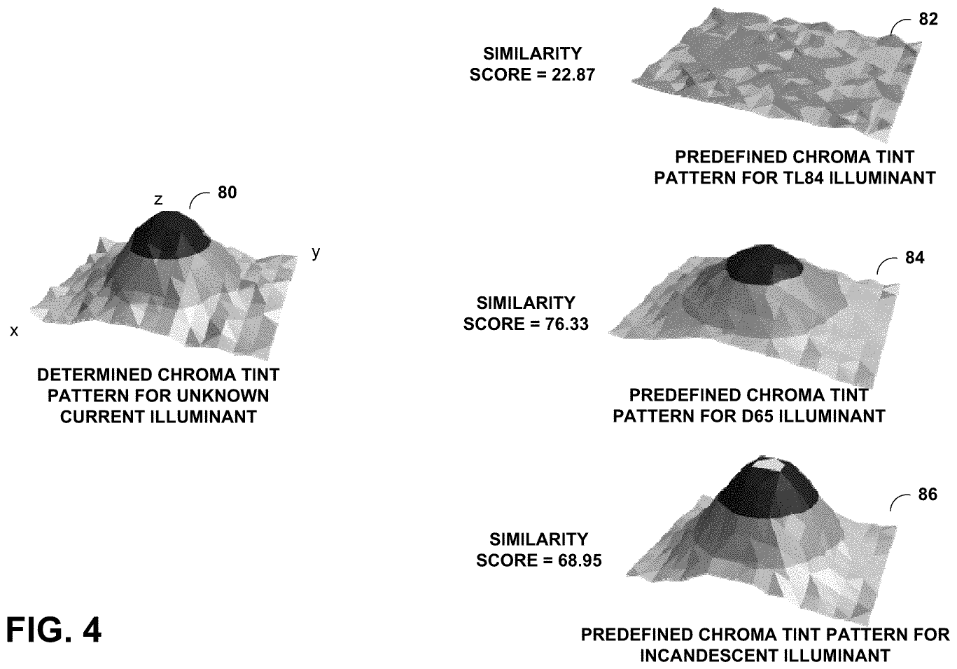

FIG. 4 is a conceptual diagram showing the comparison of a determined chroma tint pattern to predefined chroma tint patterns. FIG. 4 shows a visualization of an example of a chroma tint pattern 80 determined for an unknown current illuminant using the techniques described above with reference to FIG. 3. FIG. 4 shows the chroma tint pattern (z axis) for bins of the image in the x and y direction. Chroma tint pattern 82 is an example of a predefined chroma tint pattern for the TL84 illuminant. Chroma tint pattern 84 is an example of a predefined chroma tint pattern for the D65 illuminant. Chroma tint pattern 86 is an example of a predefined chroma tint pattern for the incandescent illuminant.

When compared to chroma tint pattern 80 using the techniques described above, chroma tint pattern 82 (TL84) has a similarity score of 22.87. When compared to chroma tint pattern 80 using the techniques described above, chroma tint pattern 84 (D65) has a similarity score of 76.33. When compared to chroma tint pattern 80 using the techniques described above, chroma tint pattern 86 (incandescent) has a similarity score of 68.95. As such, when determining between the three illuminants shown in FIG. 4, it is most likely that that image captured that produced chroma tint pattern 80 was captured under a D65 illuminant. Image signal processor 6 may then determine AWB parameters based on the D65 illuminant.

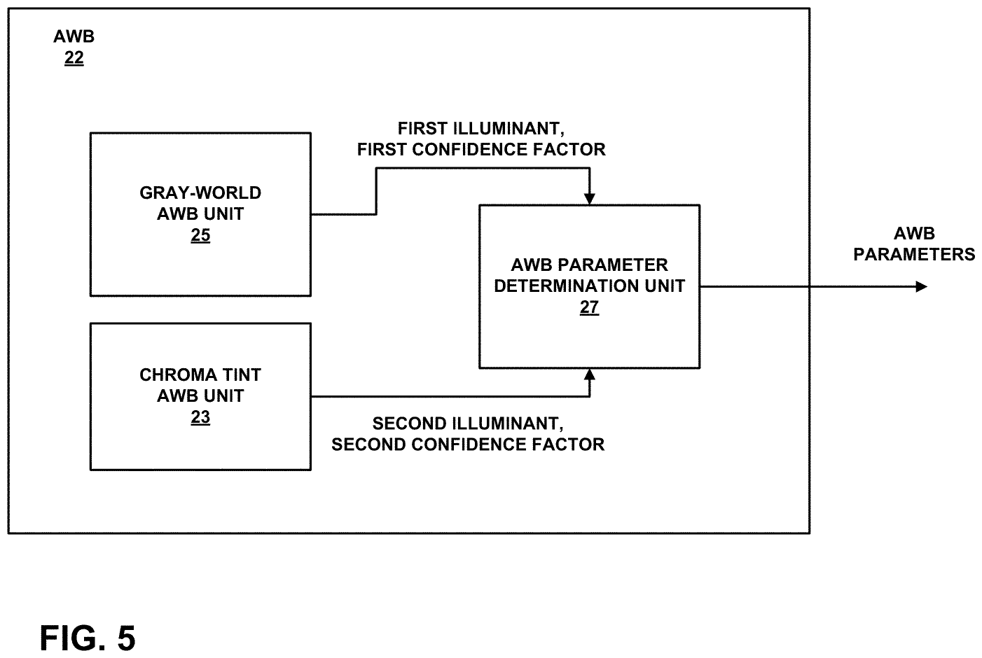

FIG. 5 is a block diagram showing gray-world automatic white balance unit 25 operating in conjunction with a chroma tint pattern AWB unit 23. In this example, gray-world AWB unit 25 may be configured to output an illuminant (first illuminant) with a first confidence factor (e.g., based on R/G statistics) before determining AWB parameters. Chroma tint pattern AWB unit 23 may be configured to output an illuminant (second illuminant) with a second confidence factor based on a similarity score using the chroma tint pattern techniques described above with reference to FIG. 3. AWB process 22 may use the output illuminants and confidence factors produced by gray-world AWB unit 25 and chroma tint AWB unit 23 to obtain a more robust and accurate white balance gain calculation.

For example, AWB parameter determination unit 27 may apply a weight to the first illuminant produced by gray-world AWB unit 25 based on the first confidence factor and apply another weight to the second illuminant produced by chroma tint pattern AWB unit 23 based on the second confidence factor. In some examples, the first and second confidence factors may themselves be weights. In other examples, AWB parameter determination unit 27 may derive weights for the first and second illuminant as a function of the first and second confidence factors. For example, in some conditions, it may be more probable that the output illuminant of the chroma tint AWB unit 23 is more likely to be correct than the output illuminant of the gray-world AWB unit 25, or vice versa. Accordingly, even if first confidence factor output by the gray-world AWB unit 25 is higher than the confidence factor of the chroma tint AWB unit 23, AWB parameter determination unit 27 may weight the output illuminant of the chroma tint AWB unit 23 more highly.

AWB parameter determination unit 27 may combine the weighted values of the first and second illuminants, along with brightness information, to determine the current illuminant under which the image was captured. For example, the first and second illuminants are the same, AWB parameter determination unit 27 will select that illuminant. If the first and second illuminants are different, AWB parameter determination unit 27 will select the illuminant having the highest weight. AWB parameter determination unit 27 may then determine the AWB parameters for the current illuminant as described above.

In another example, gray-world AWB unit 25 may have determined multiple candidate illuminants, each with their own confidence factors (e.g., first confidence factors). Each of the individual first confidence factors may be different depending on the gray statistics count for each illuminant gray statistics count in the scene and corresponding ambient light brightness info, (e.g., sunny daylight, dark indoor TL84, etc.). Likewise, chroma tint AWB unit 22 may have determined multiple candidate illuminants, each with their own confidence factors (e.g., second confidence factors). In this example, the similarity scores described above may be used directly as the second confidence factors.

For the same illuminants (e.g., TL84, D65, Incandescent, etc.) output by gray-world AWB unit 25 and chroma tint AWB unit 23, AWB parameter determination unit 27 may add the similarity scores determined by chroma tint AWB unit 23 to the weights determined for the output illuminant of gray-world AWB unit 25 and divide the result by two. This results in a weighted average for a particular illuminant. That is, AWB parameter determination unit 27 determines a weighted average between two techniques (i.e., gray world and chroma tint) that indicates the likelihood that a particular illuminant is the current illuminant. AWB parameter determination unit 27 may then determine the final AWB parameters by comparing the weighted average of multiple illuminants and choosing the illuminant that has the highest weighted average.

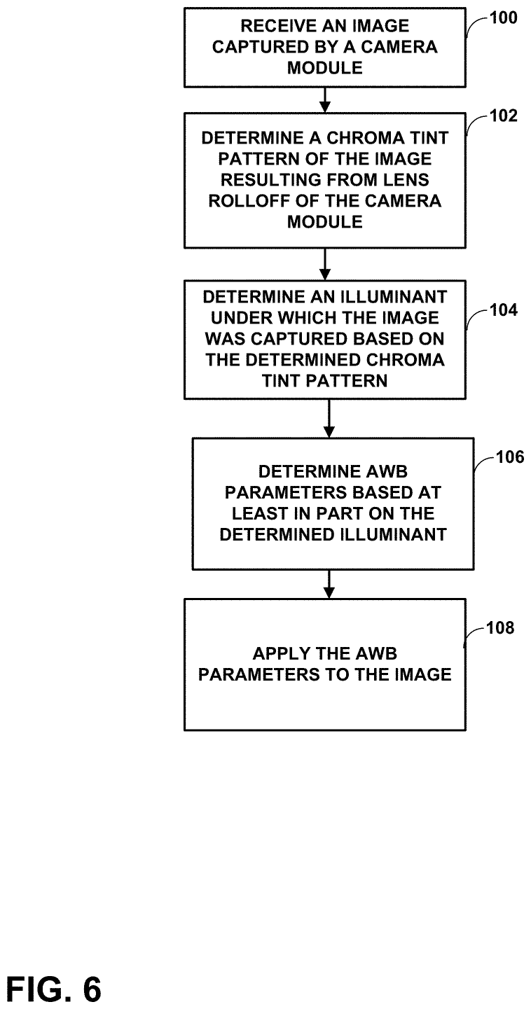

FIG. 6 is a flowchart illustrating an example method according to the techniques of the disclosure. The techniques of FIG. 6 may be performed by one or more processors, including image signal processor 6 of FIG. 1.

In one example of the disclosure, image signal processor 6 may be configured to receive an image captured by the camera module 12 (100). Image signal processor 6 (e.g., using chroma tint AWB unit 23) may be further configured to determine a chroma tint pattern 80 of the image resulting from lens rolloff of camera module 12 (102). Chroma tint AWB unit 23 may be further configured to determine an illuminant under which the image was captured based on the determined chroma tint pattern 80 (104). Image signal processor 6 may then determine AWB parameters based at least in part on the determined illuminant (106), and apply the AWB parameters to the image (108).

In one example of the disclosure, to determine the illuminant under which the image was captured based on the determined chroma tint pattern, image signal processor 6 is further configured to compare the determined chroma tint pattern to one or more predetermined chroma tint patterns. Each of the predetermined chroma tint patterns is associated with a predefined illuminant. Image signal processor 6 may be further configured to determine the illuminant based on the predetermined chroma tint pattern that most closely matches the determined chroma tint pattern based on the comparison.

In an example of the disclosure, to determine the chroma tint pattern, image signal processor 6 may be further configured to apply lens rolloff correction to the image to create a corrected image, determine a red/green ratio and a blue/green ratio for the corrected image, and apply a low pass filter to the red/green ratio and the blue/green ratio of the corrected image to determine the chroma tint pattern. In one example of the disclosure, the low pass filter is a homomorphic low pass filter.

In an example of the disclosure, to apply the homomorphic low filter, image signal processor 6 may be further configured to apply a natural logarithm to the red/green ratio and the blue/green ratio to produce a first output, and apply a Fourier transform to the first output to produce a second output. Image signal processor 6 may be further configured to apply a low pass filter to the second output to produce a third output, apply an inverse Fourier transform to the third output to produce a fourth output, and apply an exponential function to the fourth output to produce the chroma tint pattern.

In one example of the disclosure, the lens rolloff correction is a reference light condition rolloff table generated from a reference light condition. In another example of the disclosure, image signal processor 6 is further configured to apply a black level subtraction to the image before determining the chroma tint pattern.

In another example of the disclosure, to determine the red/green ratio and the blue/green ratio for the corrected image, image signal processor 6 is further configured to determine the red/green ratio and the blue/green ratio for each of a plurality of M×N bins of the corrected image.

In another example of the disclosure, the determined illuminant is a first illuminant. In this example, image signal processor 6 (e.g., using gray-world AWB unit 25) may be configured to determine a second illuminant using gray-world assumption techniques on the captured image. Image signal processor 6 may be further configured to determine a first confidence factor for the first illuminant, and determine a second confidence factor for the second illuminant. To determine the AWB parameters based at least in part on the determined first illuminant, image signal processor 6 is further configured to determine the AWB parameters based on the first illuminant, the first confidence factor, the second illuminant and the second confidence factor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for image processing, the method comprising:
receiving an image captured by a camera module;
determining a chroma tint pattern of the image resulting from lens rolloff of the camera module;
determining an illuminant under which the image was captured based on the determined chroma tint pattern;
determining auto white balance (AWB) parameters based at least in part on the determined illuminant; and
applying the AWB parameters to the image.

2. The method of claim 1, wherein determining the illuminant under which the image was captured based on the determined chroma tint pattern comprises:
comparing the determined chroma tint pattern to one or more predetermined chroma tint patterns, wherein each of the predetermined chroma tint patterns is associated with one of a plurality of predefined illuminants; and
determining the illuminant based on the predetermined chroma tint pattern that most closely matches the determined chroma tint pattern based on the comparison.

3. The method of claim 1, wherein determining the chroma tint pattern comprises:
applying lens rolloff correction to the image to create a corrected image;
determining a red/green ratio and a blue/green ratio for the corrected image; and
applying a low pass filter to the red/green ratio and the blue/green ratio of the corrected image to determine the chroma tint pattern.

4. The method of claim 3, wherein the low pass filter is a homomorphic low pass filter.

5. The method of claim 4, wherein applying the homomorphic low filter comprises:
applying a natural logarithm to the red/green ratio and the blue/green ratio to produce a first output;
applying a Fourier transform to the first output to produce a second output;
applying a low pass filter to the second output to produce a third output;
applying an inverse Fourier transform to the third output to produce a fourth output; and
applying an exponential function to the fourth output to produce the chroma tint pattern.

6. The method of claim 3, wherein the lens rolloff correction is a reference light condition rolloff table generated from a reference light condition.

7. The method of claim 3, further comprising:
applying a black level subtraction to the image before determining the chroma tint pattern.

8. The method of claim 3, wherein determining the red/green ratio and the blue/green ratio for the corrected image comprises:
determining the red/green ratio and the blue/green ratio for each of a plurality of M×N bins of the corrected image.

9. The method of claim 1, wherein the determined illuminant is a first illuminant, the method further comprising:
determining a second illuminant using gray-world assumption techniques on the captured image;
determining a first confidence factor for the first illuminant;
determining a second confidence factor for the second illuminant; and
wherein determining the AWB parameters based at least in part on the determined first illuminant comprises:
determining the AWB parameters based on the first illuminant, the first confidence factor, the second illuminant and the second confidence factor.

10. An apparatus configured for image processing, the apparatus comprising:
a memory configured to store an image captured by an image sensor of a camera module; and
one or more processors in communication with the memory, the one or processors configured to:
receive the image captured by the camera module;
determine a chroma tint pattern of the image resulting from lens rolloff of the camera module;
determine an illuminant under which the image was captured based on the determined chroma tint pattern;
determine auto white balance (AWB) parameters based at least in part on the determined illuminant; and
apply the AWB parameters to the image.

11. The apparatus of claim 10, wherein to determine the illuminant under which the image was captured based on the determined chroma tint pattern, the one or more processors are further configured to:
compare the determined chroma tint pattern to one or more predetermined chroma tint patterns, wherein each of the predetermined chroma tint patterns is associated with one of a plurality of predefined illuminants; and
determine the illuminant based on the predetermined chroma tint pattern that most closely matches the determined chroma tint pattern based on the comparison.

12. The apparatus of claim 10, wherein to determine the chroma tint pattern, the one or more processors are further configured to:
apply lens rolloff correction to the image to create a corrected image;
determine a red/green ratio and a blue/green ratio for the corrected image; and
apply a low pass filter to the red/green ratio and the blue/green ratio of the corrected image to determine the chroma tint pattern.

13. The apparatus of claim 12, wherein the low pass filter is a homomorphic low pass filter.

14. The apparatus of claim 13, wherein to apply the homomorphic low filter, the one or more processors are further configured to:
apply a natural logarithm to the red/green ratio and the blue/green ratio to produce a first output;
apply a Fourier transform to the first output to produce a second output;
apply a low pass filter to the second output to produce a third output;
apply an inverse Fourier transform to the third output to produce a fourth output; and
apply an exponential function to the fourth output to produce the chroma tint pattern.

15. The apparatus of claim 12, wherein the lens rolloff correction is a reference light condition rolloff table generated from a reference light condition.

16. The apparatus of claim 12, wherein the one or more processors are further configured to:
apply a black level subtraction to the image before determining the chroma tint pattern.

17. The apparatus of claim 12, wherein to determine the red/green ratio and the blue/green ratio for the corrected image, the one or more processors are further configured to:
determine the red/green ratio and the blue/green ratio for each of a plurality of M×N bins of the corrected image.

18. The apparatus of claim 10, wherein the determined illuminant is a first illuminant, and wherein the one or more processors are further configured to:
determine a second illuminant based gray-world assumption techniques on the captured image;
determine a first confidence factor for the first illuminant;
determine a second confidence factor for the second illuminant; and
wherein to determine the AWB parameters based at least in part on the determined first illuminant, the one or more processors are further configured to:
determine the AWB parameters based on the first illuminant, the first confidence factor, the second illuminant and the second confidence factor.

19. The apparatus of claim 10, further comprising:
the camera module configured to capture the image.

20. The apparatus of claim 19, wherein the camera module is part of a mobile telephone.

21. An apparatus configured for image processing, the apparatus comprising:
means for receiving an image captured by a camera module;
means for determining a chroma tint pattern of the image resulting from lens rolloff of the camera module;
means for determining an illuminant under which the image was captured based on the determined chroma tint pattern;
means for determining auto white balance (AWB) parameters based at least in part on the determined illuminant; and
means for applying the AWB parameters to the image.

22. The apparatus of claim 21, wherein the means for determining the illuminant under which the image was captured based on the determined chroma tint pattern comprises:
means for comparing the determined chroma tint pattern to one or more predetermined chroma tint patterns, wherein each of the predetermined chroma tint patterns is associated with one of a plurality of predefined illuminants; and
means for determining the illuminant based on the predetermined chroma tint pattern that most closely matches the determined chroma tint pattern based on the comparison.

23. The apparatus of claim 21, wherein the means for determining the chroma tint pattern comprises:
means for applying lens rolloff correction to the image to create a corrected image;
means for determining a red/green ratio and a blue/green ratio for the corrected image; and
means for applying a low pass filter to the red/green ratio and the blue/green ratio of the corrected image to determine the chroma tint pattern.

24. The apparatus of claim 23, wherein the low pass filter is a homomorphic low pass filter.

25. The apparatus of claim 24, wherein the means for applying the homomorphic low filter comprises:
means for applying a natural logarithm to the red/green ratio and the blue/green ratio to produce a first output;
means for applying a Fourier transform to the first output to produce a second output;
means for applying a low pass filter to the second output to produce a third output;
means for applying an inverse Fourier transform to the third output to produce a fourth output; and
means for applying an exponential function to the fourth output to produce the chroma tint pattern.

26. A non-transitory computer-readable storage medium storing instructions that, when executed, causes one or more processors to:
receive an image captured by a camera module;
determine a chroma tint pattern of the image resulting from lens rolloff of the camera module;
determine an illuminant under which the image was captured based on the determined chroma tint pattern;
determine auto white balance (AWB) parameters based at least in part on the determined illuminant; and
apply the AWB parameters to the image.

27. The non-transitory computer-readable storage medium of claim 26, wherein to determine the illuminant under which the image was captured based on the determined chroma tint pattern, the instructions further cause the one or more processors to:
compare the determined chroma tint pattern to one or more predetermined chroma tint patterns, wherein each of the predetermined chroma tint patterns is associated with one of a plurality of predefined illuminants; and
determine the illuminant based on of the predetermined chroma tint patterns that most closely matches the determined chroma tint pattern based on the comparison.

28. The non-transitory computer-readable storage medium of claim 26, wherein to determine the chroma tint pattern, the instructions further cause the one or more processors to:
apply lens rolloff correction to the image to create a corrected image;
determine a red/green ratio and a blue/green ratio for the corrected image; and
apply a low pass filter to the red/green ratio and the blue/green ratio of the corrected image to determine the chroma tint pattern.

29. The non-transitory computer-readable storage medium of claim 28, wherein the low pass filter is a homomorphic low pass filter.

30. The non-transitory computer-readable storage medium of claim 29, wherein to apply the homomorphic low filter, the instructions further cause the one or more processors to:
apply a natural logarithm to the red/green ratio and the blue/green ratio to produce a first output;
apply a Fourier transform to the first output to produce a second output;
apply a low pass filter to the second output to produce a third output;
apply an inverse Fourier transform to the third output to produce a fourth output; and
apply an exponential function to the fourth output to produce the chroma tint pattern.
